(19) United States
(12) Patent Application Publication
(10) Pub. No.: US 2005/0131945 A1
(43) Pub. Date: Jun. 16, 2005

(54) Compact interface for the display and navigation of object hierarchies

(75) Inventors: Michael Muller, Medford, MA (US); Vaughn T. Rokosz, Newton, MA (US); Andrew L. Schirmer, Andover, MA (US); Jennifer J. Smith, Boston, MA (US)

Correspondence Address: HOFFMAN WARNICK & D'ALESSANDRO, LLC, 3 E-COMM SQUARE, ALBANY, NY, 12207, US

(73) Assignee: International Business Machines Corporation, Armonk, NY (US)

(21) Appl. No.: 10/737,300

(22) Filed: Dec. 16, 2003

(51) Int. Cl. G06F 17/00

(52) U.S. Cl. 707/104.1

(57) ABSTRACT

Under the present invention, a method, system, interface and program product for displaying an object hierarchy in a compact form, and for facilitating navigation through the displayed object hierarchy, is provided. The method includes: displaying a first level root node of the object hierarchy; upon selection of the first level root node, displaying a listing of all second level child nodes of the first level root node immediately adjacent the first level root node; and selecting one of the second level child nodes; wherein, upon selection of one of the second level child nodes, the listing of all second level child nodes of the first level root node disappears, and the selected second level child node is displayed immediately adjacent the first level root node. Nodes from additional levels of the object hierarchy can be selected and displayed in a similar manner.

### BACKGROUND OF THE INVENTION

1. Field of the Invention

The present invention generally relates to the display of object hierarchies. More specifically, the present invention provides a method, system, interface, and computer program product for displaying object hierarchies in a compact form, and for facilitating navigation through the object hierarchies.

2. Background Art

Computer software systems often contain hierarchies of objects. For example, file systems are often represented as tree structures and/or nested folders containing files. Hierarchies are also used to represent taxonomies of ideas, directories of people, and so forth.

Providers of hierarchical structures generally provide a graphical user interface (GUI) that allows computer users to view, manipulate, and navigate through the structure and content of a hierarchy. Object hierarchies in modern systems are apt to contain large numbers of items, both structure and content, and so it becomes increasingly difficult to display and navigate through the hierarchies. Further, when functions or operations are associated with each respective item, it becomes increasingly difficult to find and execute the desired functionality.

Examples of file system object hierarchies available today are illustrated in FIGS. 1-4. FIG. 1, for example, illustrates an outline-style file browser 10 in accordance with the related art, which organizes and displays folder/file information using expandable containers (i.e., folders). As shown in FIG. 1, a selected folder 12 in the left pane 14 can be expanded to show folders/files within that folder 12. A separate pane 16, displayed to the right of pane 14, is required to view the files within the folder 12 selected in the left pane 14. This type of file system requires multiple panes, which take up a lot of space on a display. Also, expanding and collapsing folders to navigate through the file system is cumbersome and time consuming.

FIG. 2 illustrates a multi-pane file viewer 20 in accordance with the related art. In multi-pane viewer 20, a container (e.g., a hard-drive) labeled “Greg” is selected in pane 22, a “.sit” archive labeled “Thesis.sit” and located within “Greg” is selected in pane 24, while the contents of the “.sit” archive are shown in pane 26. As with the outline-style file browser 10 described above, multi-pane viewer 20 requires multiple panes, which take up a lot of space on a display. Also, selecting folders or other containers within multi-pane viewer 20 is cumbersome and time consuming. Further, navigating deeper than three levels requires either adding additional panes to the right, or losing higher level panes on the left.

The hyperbolic tree browser 30 shown in FIG. 3 is another commonly used browser for viewing and navigating through an object hierarchy. When a leaf 32 in the tree browser 30 is selected, that leaf 32 moves to the central focus, while peripheral leaves remain in view, but off to the side. Although this method of displaying object hierarchies is capable of displaying a large amount of data, it is often difficult to see complete paths within the tree browser, since the leaves displayed off to the side may be crowded together (see, e.g., group 34 of leaves).

FIG. 4 illustrates the display of an object hierarchy using cascading menus 40, as known in the art. As shown, when the item “Recent Applications” in window 42 is selected, a pop-up window 44 listing the contents of the item “Recent Applications” appears to the right of window 42. This method of displaying an object hierarchy is very inefficient because a user must always start navigating at the top level of the hierarchy. Further, the use of cascading windows 40 is very cumbersome and can take up a lot of display space, especially when navigating through deep hierarchies.

In view of the foregoing, there exists a need for a method, system, interface and program product for displaying an object hierarchy in a compact form, and for facilitating navigation through the displayed object hierarchy.

### SUMMARY OF THE INVENTION

In general, the present invention provides a method, system, interface and program product for displaying an object hierarchy in a compact form, and for facilitating navigation through the displayed object hierarchy. The present invention provides information regarding the current location within an object hierarchy in a compact form, and also provides a mechanism for displaying the complete structure of the hierarchy, or selected portions thereof, without taking up additional space. Navigation through the hierarchy is highly manageable and time efficient. The compact interface of the present invention provides multiple expansion mechanisms that allow a user to see, for example: current location within the hierarchy (i.e., self); containment hierarchy above the current location (i.e., ancestors back to the root of the hierarchy); other items at the same level as the current location (i.e., siblings); and items immediately below the current level (i.e., children). In fact, some or all items in the hierarchy anywhere above, at the same level as, or below the current level can be selectively viewed at once.

The compact interface of the present invention displays at least one node in a linear arrangement, with each node in the compact interface representing a different level (e.g., generation) in an object hierarchy. For example, the nodes displayed by the compact interface may include a root node (e.g., a first generation node), followed by a child of the root node (e.g., a second generation node), followed by a grandchild of the root node (e.g., a third generation node), etc. When a node is selected, for example, with a mouse or other selection mechanism, the child nodes (if any) of the selected node are all displayed (e.g., in a pop-up window) immediately adjacent the selected node, allowing a user to easily navigate to the next level of the object hierarchy. This may be done, for example, by clicking on a node with a mouse and holding the mouse button down (i.e., via a “click and hold gesture” using the mouse). Upon selection of a node, the compact interface is updated/reset to indicate the user's current location in the object hierarchy.

In accordance with a first aspect of the present invention, a method for providing a compact interface for display of an object hierarchy having a plurality of levels is provided, wherein the method comprises: displaying a first level root node of the object hierarchy; upon selection of the first level root node, displaying a listing of all second level child nodes of the first level root node immediately adjacent the first level root node; and selecting one of the second level child nodes; wherein, upon selection of one of the second level child nodes, the listing of all second level child nodes of the first level root node disappears, and the selected second level child node is displayed immediately adjacent the first level root node.

A second aspect of the present invention provides a system for providing a compact interface for display of an object hierarchy having a plurality of levels, comprising: a display system for displaying elements of the compact interface; a system for selecting displayed elements of the compact interface; and a system for updating the compact interface based of the elements selected by the selecting system; wherein, upon selection of a displayed first level root node, a listing of all second level child nodes of the first level root node is displayed immediately adjacent the first level root node, and wherein, upon selection of one of the second level child nodes, the listing of all second level child nodes of the first level root node is no longer displayed, and the selected second level child node is displayed immediately adjacent the first level root node.

A third aspect of the present invention provides a compact interface for displaying an object hierarchy having a plurality of levels, comprising: a first level root node of the object hierarchy; a single second level node of the object hierarchy, wherein the second level node is a child of the first level root node; and a single third level node of the object hierarchy, wherein the third level node is a child of the second level node; wherein the first level root node, second level node, and third level node are displayed in a linear arrangement, wherein the first level root node and second level node are live, and wherein the third level node is live if it has any child nodes.

A fourth aspect of the present invention provides a program product stored on a recordable medium for providing a compact interface for display of an object hierarchy having a plurality of levels, which when executed comprises: program code for displaying a first level root node of the object hierarchy; program code for displaying a listing of all second level child nodes of the first level root node immediately adjacent the first level root node, upon selection of the first level root node; and program code for causing the listing of all second level child nodes of the first level root node to disappear upon selection of one of the second level child nodes, and for displaying the selected second level child node immediately adjacent the first level root node.

Therefore, the present invention provides a method, system, interface, and program product for displaying an object hierarchy in a compact form, and for facilitating navigation through the displayed object hierarchy.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an example of an outline-style file browser in accordance with the related art.

FIG. 2 depicts an example of a multi-pane file viewer in accordance with the related art.

FIG. 3 depicts an example of a hyperbolic tree browser in accordance with the related art.

FIG. 4 depicts the display of an object hierarchy using cascaded menus, as known in the related art.

FIG. 5 illustrates an exemplary compact interface in accordance with the present invention, with the compact interface is in its default, non-expanded state.

FIG. 6 illustrates an exemplary four-level object hierarchy displayed by the compact interface of the present invention.

FIGS. 7-10 illustrate navigation through the object hierarchy of FIG. 6, using the compact interface of the present invention.

FIGS. 11-14 illustrate variations for navigation through the object hierarchy of FIG. 6, using the compact interface of the present invention.

FIG. 15 illustrates a computer system for implementing the compact interface of the present invention.

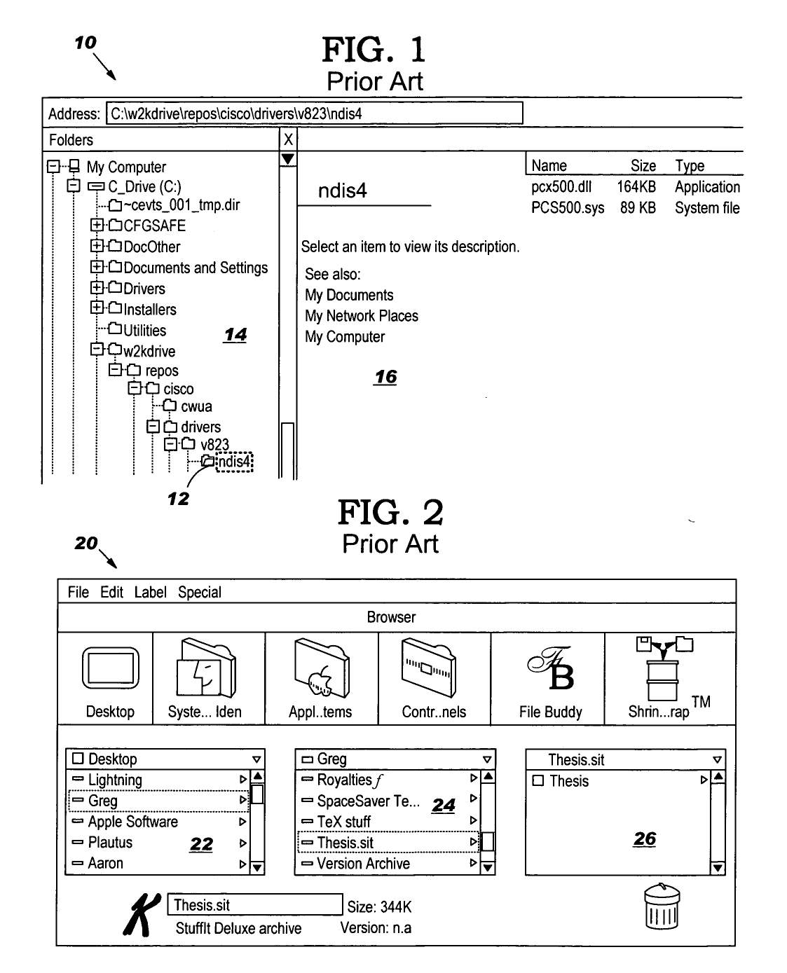

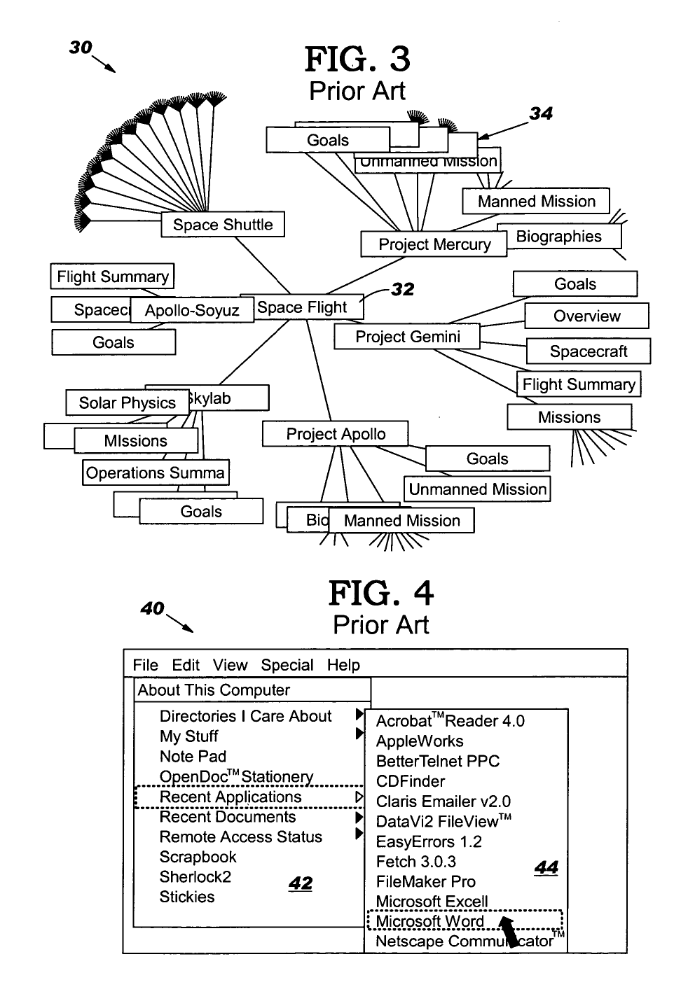

The drawings are merely schematic representations, not intended to portray specific parameters of the invention, and are not necessarily to scale. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a method, system, interface and program product for displaying an object hierarchy in a compact form, and for facilitating navigation through the displayed object hierarchy. The present invention provides information regarding the current location within the hierarchy in a compact form, and also provides a mechanism for displaying the complete structure of the hierarchy, or selected portions thereof, without taking up additional space. Navigation through the hierarchy is highly manageable and time efficient. The compact interface of the present invention can be selectively configured to provide multiple expansion mechanisms that allow a user to see, for example, the current location within the hierarchy (i.e., self), the containment hierarchy above the current location (i.e., ancestors back to the root of the hierarchy), other items at the same level as the current location (i.e., siblings), and items immediately below the current level (i.e., children). Advantageously, some or all items in the hierarchy anywhere above, at the same level as, or below the current level can be selectively viewed at once.

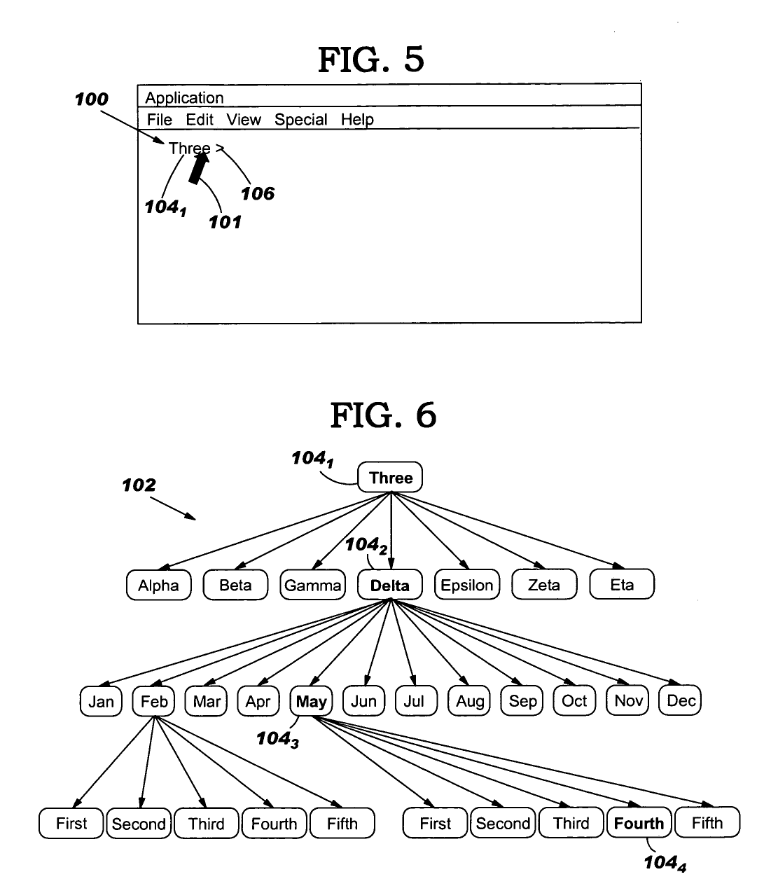

An exemplary compact interface 100 in accordance with the present invention is illustrated in FIG. 5. In this example, the compact interface 100 is used to display information in a four-level object hierarchy 102 (FIG. 6). However, it should be apparent to one skilled in the art that the compact interface 100 of the present invention can be used to display information in any type of object hierarchy having any number of levels.

As shown in FIG. 5, the compact interface 100, in its default, non-expanded state, displays a single node (“Three”) corresponding to the root node “Three” (104₁) of the four-level object hierarchy 102 (FIG. 6). Navigation indicia 106, such as a “greater than” sign “>,” is displayed adjacent the root node “Three” (104₁) to indicate to a user that the object hierarchy 102 represented by the compact interface 100 includes at least one additional level to which a user may navigate.

Each node having at least one child node, when displayed in the compact interface 100, is considered “live.” That is, clicking or otherwise activating a “live” node in the compact interface 100 produces an action (e.g., causes a pop-up window to appear). The live nodes in the compact interface 100 can be displayed with underlining to indicate their “liveness” (i.e., similar to the use of links in a web browser), or the “liveness” of a node may be displayed when a user hovers a cursor over a live node (e.g., with the cursor tuning into a hand with a pointing finger). Many other methods for indicating “liveness” are also available and can be used in the practice of the present invention. For example, a control element, such as a down arrow, can be positioned adjacent each live node in the compact interface 100. The mechanisms used to indicate “liveness” can vary according to many factors, including, for example, designer preference and user interface standards, and are not limited by the examples described above.

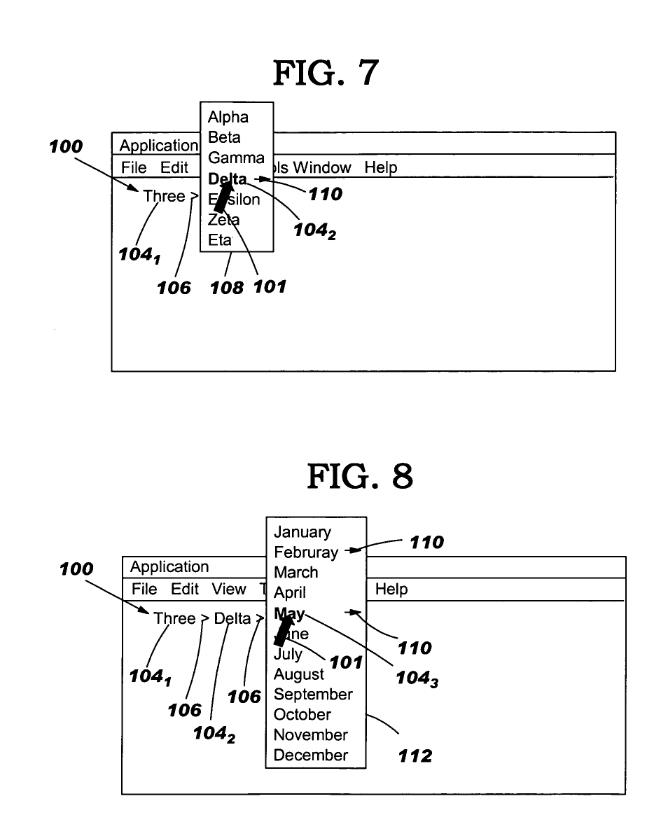

As shown in FIG. 7, when a user activates the root node “Three” (104₁) in the compact interface 100, the child nodes of root node “Three” (104₁) are displayed in a pop-up window 108 located immediately adjacent and to the right of the root node “Three” (104₁). The user can then easily navigate to the next level of the object hierarchy 102 containing the child nodes of root node “Three” (104₁). This can be done, for example, via a “click and hold” gesture using a mouse (i.e., clicking on the root node “Three” (104₁) with a mouse pointer, holding down the mouse button, and moving the mouse pointer to a desired location), or by tabbing to the root node “Three” (104₁) and then pressing the “Enter” key (e.g., for accessibility by users with limited vision or limited ability to use a mouse or other pointing device). In this example, the child nodes of root node “Three” (104₁) comprise the nodes “Alpha,” “Beta,” “Gamma,” “Delta,” “Epsilon,” “Zeta,” and “Eta.” The child node “Delta” (104₂) includes navigation indicia 110 (e.g., an arrow) indicating that it has at least one child node to which a user may navigate, if desired. The child nodes “Alpha,” “Beta,” “Gamma,” “Epsilon,” “Zeta,” and “Eta,” do not include navigation indicia, and are therefore end nodes or “leaves” of root node “Three” (104₁).

Upon selection of a child node of the root node “Three” (104₁), in this example the child node “Delta” (104₂), the compact interface 100 is updated/reset as illustrated in FIG. 8 to “Three>Delta>.” Comparing FIG. 7 to FIG. 8, it can be seen that, upon selection of the child node “Delta” (104₂), the pop-up window 108 has disappeared and has been replaced by the node “Delta” (104₂) in the compact interface 100. Thus, the pop-up window 108 and the child node “Delta” (104₂) are positioned in the same location relative to the root node “Three” (104₁) in the compact interface 100. In addition, the child nodes of the node “Delta” (104₂) are displayed in a pop-up window 112 located immediately adjacent and to the right of the node “Delta” (104₂) in the compact interface 100. The user can then navigate to, and select from, the child nodes of the node “Delta” (104₂) using, for example, a “click and hold” mouse gesture.

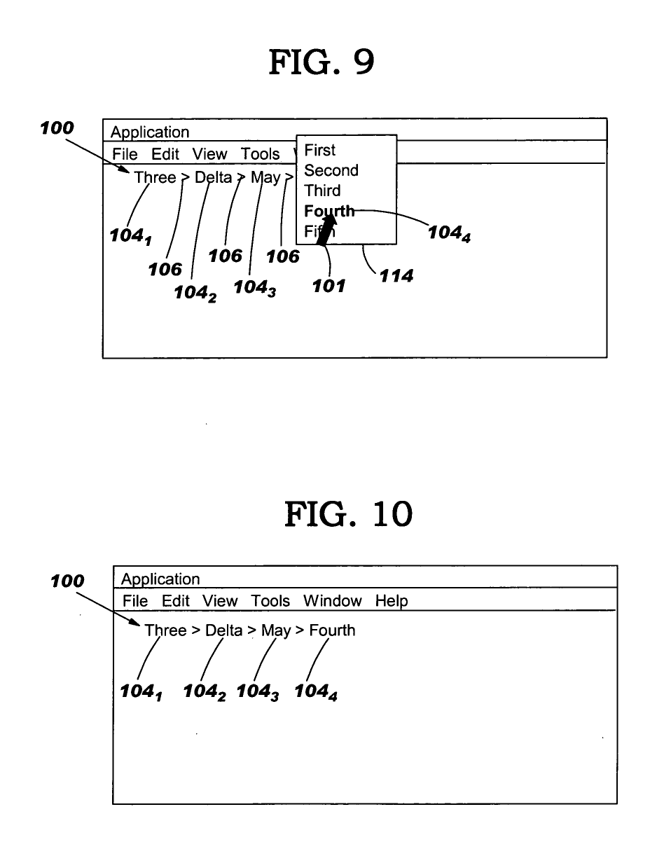

Navigation to deeper levels of the object hierarchy can continue in the manner described above. For example, in FIG. 9, the child node “May” (104₃) of the node “Delta” (104₂) has been selected, the compact interface 100 has been updated to indicate this selection (i.e., “Three>Delta>May”), and the child nodes of the node “May” (104₃) are displayed in a pop-up window 114 located immediately adjacent and to the right of node “May” (104₃) in the compact interface 100. Upon subsequent navigation to the child node “Fourth” (104₄) of the node “May” (104₃), the compact interface 100 is updated as indicated in FIG. 10.

As depicted in FIGS. 7-10, the compact interface 100 comprises a linear, horizontal arrangement of the nodes in the object hierarchy 102 that have been selected by a user. The depth of the navigation path followed by the user through the object hierarchy 102 increases from left to right in the compact interface 100. The compact interface 100, therefore, provides information regarding the path navigated by the user through the object hierarchy 102, as well as information regarding the current location within the object hierarchy 102. The compact interface 100 may also be configured to present the selected nodes such that the depth of the navigation path followed by the user through the object hierarchy 102 increases from right to left. This may be useful, for example, where the compact interface 100 is implemented in languages that are read from right to left. Further, the linear arrangement of selected nodes may be arranged vertically, diagonally, or in any other orientation. However, the horizontal arrangement of the compact interface 100 provides the most efficient use of space for most English or European-language users.

In accordance with the present invention, a user can easily navigate from the root node “Three” (104₁) to deeper levels of the object hierarchy 102 using the compact interface 100. For example, a user may select the root node “Three” (104₁) with the mouse pointer 101, slide the mouse pointer 101 first to the child node “Delta” (104₂) and then to the grandchild node “May” (104₃), while still holding down the mouse button, and finally position the mouse pointer on the leaf node “Fourth.” Thus, navigation is accomplished very simply by sliding the mouse pointer, while holding down a mouse button, from the root node “Three” (104₁) to the leaf node “Fourth” (104₄).

It should be noted that if a user moves back up the object hierarchy 102 and selects any of the higher level nodes 104₁, 104₂, and/or 104₃ displayed in the compact interface 100, the compact interface 100 is reset to that level in the object hierarchy 102. For example, referring to FIG. 10, if a user moves upward through the object hierarchy 10 from the node “Fourth” (104₄) to the node “Delta” (104₂), the compact interface would be reset to “Three>Delta>.” Similarly, as detailed above, the compact interface 100 is continuously updated/reset to indicate the path traveled by a user as the user navigates down into the object hierarchy 102. Thus, the compact interface 100 of the present invention provides a “bread-crumb trail” (e.g., “Three>Delta>May>Fourth”) that informs a user of their current location within an object hierarchy, and the path they took down through the object hierarchy to get to the current location. This allows a user to easily navigate to lower and higher levels of the object hierarchy. That is, the compact interface 100 is self-documenting.

It should be noted that at any stage in the navigation through the compact interface 100, a user can perform an action on any node currently displayed in the compact interface 100. For example, the user may decide to “open,” “copy,” or perform other conventional actions on the nodes/leaves displayed in the compact interface 100.

It should also be noted that each node may be associated with a functionality. In one embodiment, for example, the functionality may be to display the contents of a document associated with the node. In a second embodiment, the functionality may be to execute options, processes, etc., that are external to the compact interface, such as choosing among a plurality of communication options, displaying information about organizations or persons, or controlling complex industrial processes. Many other types of functionality may also be provided.

As detailed above, when a node having children is selected (e.g., with a mouse or other selection mechanism), a pop-up window displaying the children of the selected node appears immediately adjacent to the selected node. As shown in FIG. 7, for example, selection of the root node “Three” (104₁) results in the appearance of pop-up window 108 listing the children of the root node “Three” (104₁) (i.e., “Alpha,” “Beta,” “Gamma,” “Delta,” “Epsilon,” “Zeta,” and “Eta”). It should be noted, however, that the compact interface 100 of the present invention may also be selectively configured to simultaneously display all or part of the object hierarchy 102 to further facilitate navigation through the object hierarchy 102. Four examples of display and navigation variations are presented below; others are also possible. Regardless of the variation employed, a user can easily navigate to another location in the object hierarchy 102 simply by using a “click and hold” mouse gesture to move the mouse pointer to the desired menu item, and then releasing the mouse button. Of course, other navigation/selection mechanisms may also be used in the practice of the present invention.

Each of the display and navigation variations can be selected using any suitable type of pre-set or user-defined selection mechanism, and can be used at any time while navigating through the object hierarchy 102. For example, a specific display and navigation variation may be selected using a “click and hold” mouse gesture of a predetermined time duration, a “click and hold” mouse gesture in combination with the actuation of a control key (e.g., “Shift,” “Alt,” “Ctrl,” etc.), clicking on a node while holding down a secondary mouse button (e.g., the right mouse button) and/or a control key, etc. As should be apparent to one skilled in the art, many other selection mechanisms are also possible.

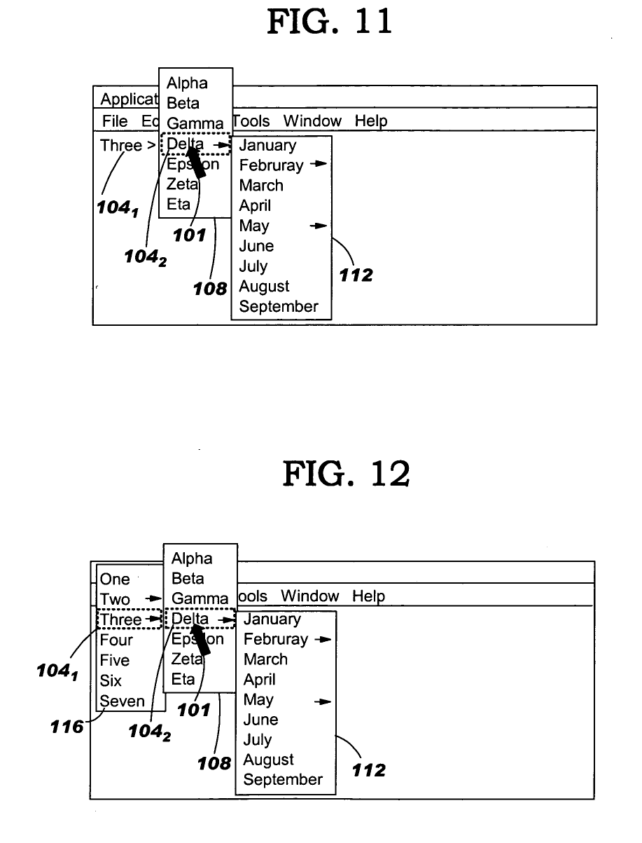

A first example of a display and navigation variation is illustrated in FIG. 11. In this example, upon selection of a node in the compact interface 100, the siblings and children (if any) of the selected node are simultaneously displayed. In FIG. 11, for example, the node “Delta” (104₂) has been selected using mouse pointer 101. This results in the appearance of a pop-up window 108 displaying the node “Delta” (104₂) and its siblings (“Alpha,” “Beta,” “Gamma,” “Epsilon,” “Zeta,” and “Eta” ). As shown in FIG. 11, the pop-up window 108 appears directly over the selected node “Delta” (104₂). In addition, a pop-up window 112 displaying the children (“January”-“December”) of the selected node “Delta” (104₂) appears immediately adjacent and to the right of the pop-up window 108.

A second example of a display and navigation variation is illustrated in FIG. 12. In this example, upon selection of a node in the compact interface 100, the siblings and children (if any) of the selected node and at least one level of ancestors of the selected node are simultaneously displayed. The number of ancestor levels that are displayed may be pre-selected by a user (e.g., in a preference file), selected in response to a predefined user action (e.g., keystroke or the like), or selected using other suitable selection mechanisms. As shown in FIG. 12, for example, the node “Delta” (104₂) has been selected using mouse pointer 101, resulting in the appearance of a pop-up window 108 displaying the node “Delta” (104₂) and its siblings. Again, the pop-up window 108 appears directly over the selected node “Delta” (104₂). In addition, a pop-up window 112 displaying the children of the selected node “Delta” (104₂) appears immediately adjacent and to the right of the pop-up window 108, and a pop-up window 116 containing the ancestors (“One”-“Seven”) of the selected node “Delta” (104₂) appears immediately adjacent and to the left of the pop-up window 108.

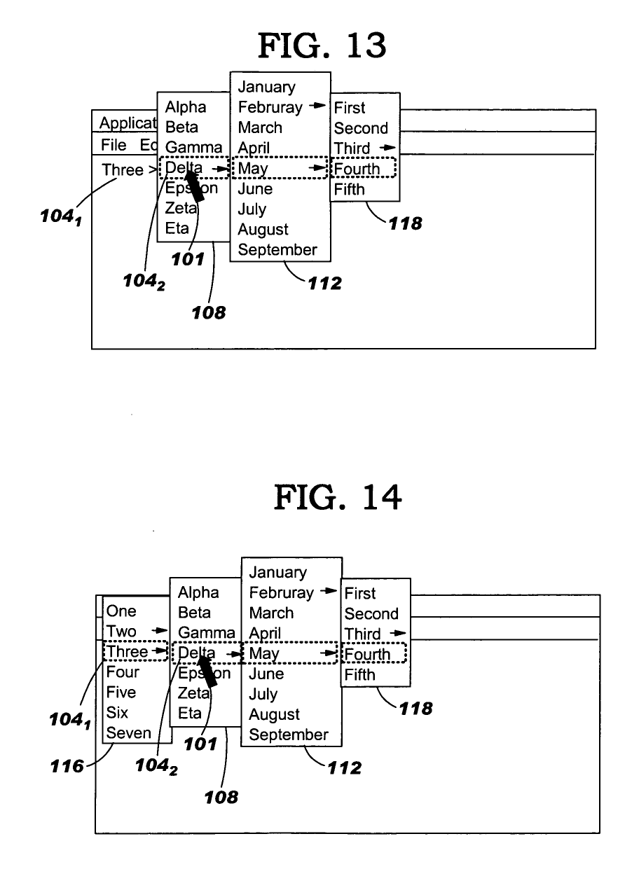

A third example of a display and navigation variation is illustrated in FIG. 13. In this example, upon selection of a node in the compact interface 100, all siblings and at least one level of descendants (if any) of the selected node are simultaneously displayed. Again, the number of descendant levels that are displayed may be pre-selected by a user (e.g., in a preference file), selected in response to a predefined user action (e.g., keystroke or the like), or selected using other suitable selection mechanisms. As shown in FIG. 13, for example, the node “Delta” (104₂) has been selected using mouse pointer 101, resulting in the appearance of a pop-up window 108 displaying the node “Delta” (104₂) and its siblings. In addition, a pop-up window 112 displaying the children of the selected node “Delta” (104₂) appears immediately adjacent and to the right of the pop-up window 108, and a pop-up window 118 displaying the grandchildren of the selected node “Delta” (104₂) appears immediately adjacent and to the right of the pop-up window 112.

A fourth example of a display and navigation variation is illustrated in FIG. 14. In this example, upon selection of a node in the compact interface 100, all ancestors, siblings and descendants (if any), of the selected node are simultaneously displayed. As shown in FIG. 14, for example, the node “Delta” (104₂) has been selected using mouse pointer 101, resulting in the appearance of a pop-up window 108 displaying the node “Delta” (104₂) and its siblings. In addition, a pop-up window 112 displaying the children of the selected node “Delta” (104₂), a pop-up window 118 displaying the grandchildren of the selected node “Delta” (104₂), and a pop-window 116 displaying the ancestors of the selected node “Delta” (104₂) are all displayed. To this extent, all of the nodes in the object hierarchy 102 (FIG. 6) are displayed in a very compact manner in FIG. 14.

At times it may be desirable to use other presentations of an object hierarchy to provide additional functionality, such as selecting and acting on multiple elements in the object hierarch at once. Additional gestures can be provided to trigger alternate displays for this purpose. A right click, link, or other mechanism could be used to invoke a dialog, for example. Use of the present invention, therefore, does not preclude the use of other interfaces.

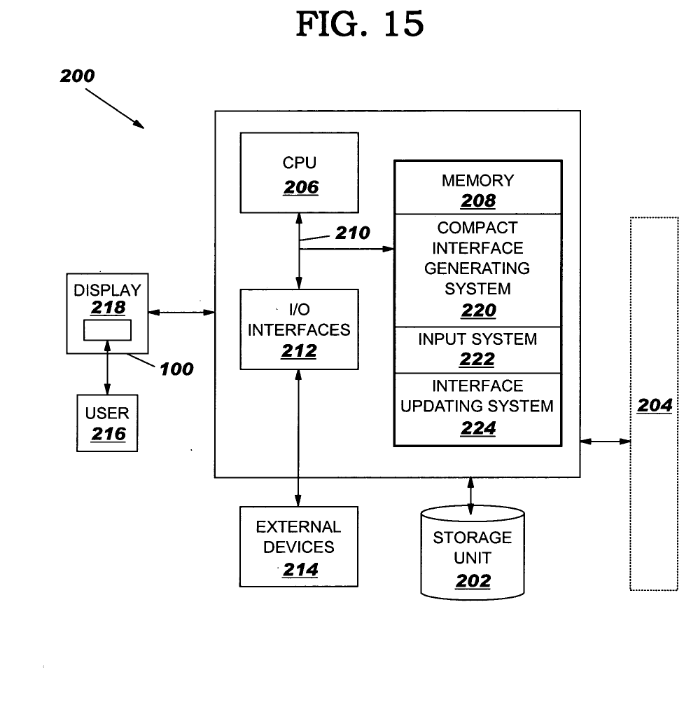

Referring now to FIG. 15, there is illustrated a computer system 200 for providing and displaying the compact interface 100 of the present invention. Computer system 200 is intended to represent any type of computerized system capable of implementing the compact interface 100 of the present invention. For example, computer system 200 may comprise a desktop computer, laptop, workstation, server, PDA, cellular phone, pager, etc.)

The data corresponding to an object hierarchy to be displayed using the compact interface 100 may be stored locally to computer system 200 in a storage unit 202, and/or may be provided to computer system 200 over a network 204. Storage unit 202 can be any system capable of providing storage for information under the present invention. As such, storage unit 202 may reside at a single physical location, comprising one or more types of data storage, or may be distributed across a plurality of physical systems in various forms. In another embodiment, storage unit 202 may be distributed across, for example, a local area network (LAN), wide area network (WAN) or a storage area network (SAN) (not shown). Network 204 is intended to represent any type of network over which users data can be transmitted. For example, network 204 can include the Internet, a wide area network (WAN), a local area network (LAN), a virtual private network (VPN), a WiFi network, or other type of network. To this extent, communication can occur via a direct hardwired connection or via an addressable connection in a client-server (or server-server) environment that may utilize any combination of wireline and/or wireless transmission methods. In the case of the latter, the server and client may utilize conventional network connectivity, such as Token Ring, Ethernet, WiFi or other conventional communications standards. Where the client communicates with the server via the Internet, connectivity could be provided by conventional TCP/IP sockets-based protocol. In this instance, the client would utilize an Internet service provider to establish connectivity to the server.

As shown, computer system 200 generally includes a central processing unit (CPU) 206, memory 208, bus 210, input/output (I/O) interfaces 212 and external devices/resources 214. CPU 206 may comprise a single processing unit, or may be distributed across one or more processing units in one or more locations, e.g., on a client and server. Memory 208 may comprise any known type of data storage and/or transmission media, including magnetic media, optical media, random access memory (RAM), read-only memory (ROM), etc. Moreover, similar to CPU 206, memory 208 may reside at a single physical location, comprising one or more types of data storage, or be distributed across a plurality of physical systems in various forms.

1/0 interfaces 212 may comprise any system for exchanging information to/from an external source. External devices/resources 214 may comprise any known type of external device, including speakers, a CRT, LED screen, handheld device, keyboard, mouse, voice recognition system, speech output system, printer, monitor/display, facsimile, pager, etc. In FIG. 15, the compact interface 100 is displayed to a user 216 on a monitor/display 218.

Bus 210 provides a communication link between each of the components in computer system 200, and likewise may comprise any known type of transmission link, including electrical, optical, wireless, etc. In addition, although not shown, additional components, such as cache memory, communication systems, system software, etc., may be incorporated into computer system 100.

Shown in memory 208 is a compact interface generating system 220 for generating a compact interface 100 based on data corresponding to an object hierarchy stored in storage unit 202. Also shown in memory 208 is an input system 222 for receiving and interpreting navigation/display input signals (e.g., mouse clicks, keystrokes, etc.) input by user 216 when navigating through the object hierarchy, and an updating system 224 for updating the compact interface 100 based on the input signals provided by user 216. If one of the displayed nodes has an associated functionality, and that node is selected, CPU 206 executes the functionality associated with the selected node.

It should be understood that the present invention can be realized in hardware, software, or a combination of hardware and software. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A method for providing a compact interface for display of an object hierarchy having a plurality of levels, comprising:
displaying a first level root node of the object hierarchy;
upon selection of the first level root node, displaying a listing of all second level child nodes of the first level root node immediately adjacent the first level root node; and
selecting one of the second level child nodes;
wherein, upon selection of one of the second level child nodes, the listing of all second level child nodes of the first level root node disappears, and the selected second level child node is displayed immediately adjacent the first level root node.

2. The method of claim 1, further comprising:
upon selection of the displayed second level child node, listing all third level child nodes of the displayed second level child node immediately adjacent the displayed second child node; and
selecting one of the third level child nodes;
wherein, upon selection of one of the third level child nodes, the window listing all third level child nodes of the displayed second level child node disappears, and the selected third level child node is displayed immediately adjacent the displayed second child node.

3. The method of claim 2, further comprising:
selectively repeating the above-described steps for at least one subsequent level in the object hierarchy, wherein each selected node is displayed immediately adjacent a selected node from a previous level of the object hierarchy.

4. The method of claim 3, wherein the first level root node and any selected nodes are displayed in a linear arrangement, wherein only a single node is displayed for each level of the object hierarchy.

5. The method of claim 4, further comprising, upon selection of one of the displayed nodes:
displaying a listing of all sibling nodes of the selected displayed node, and a listing of all child nodes of the selected displayed node adjacent the selected displayed node.

6. The method of claim 4, further comprising, upon selection of one of the displayed nodes:
displaying a listing of at least one level of ancestor nodes of the selected displayed node, a listing of all sibling nodes of the selected displayed node, and a listing of all child nodes of the selected displayed node.

7. The method of claim 4, further comprising, upon selection of one of the displayed nodes:
displaying a listing of each level of ancestor nodes of the selected displayed node, a listing of all sibling nodes of the selected displayed node, and a listing of each level of descendant nodes of the selected displayed node.

8. The method of claim 1, further comprising:
associating at least one of the displayed nodes with a functionality; and
upon selection of one of the displayed nodes, executing the functionality associated with the selected node.

9. A system for providing a compact interface for display of an object hierarchy having a plurality of levels, comprising:
a display system for displaying elements of the compact interface;
a system for selecting displayed elements of the compact interface; and
a system for updating the compact interface based of the elements selected by the selecting system;
wherein, upon selection of a displayed first level root node, a listing of all second level child nodes of the first level root node is displayed immediately adjacent the first level root node, and wherein, upon selection of one of the second level child nodes, the listing of all second level child nodes of the first level root node is no longer displayed, and the selected second level child node is displayed immediately adjacent the first level root node.

10. The system of claim 9, wherein, upon selection of the displayed second level child node, a listing of all third level child nodes of the second level child node is displayed immediately adjacent the second child node, and wherein, upon selection of one of the third level child nodes, the window listing all third level child nodes of the second level child node is no longer displayed, and the selected third level child node is displayed immediately adjacent the second child node.

11. The system of claim 10, wherein each selected node is displayed immediately adjacent a selected node from a previous level of the object hierarchy.

12. The system of claim 11, wherein the first level root node and any selected nodes are displayed in a linear arrangement, wherein only a single node is displayed for each level of the object hierarchy.

13. The system of claim 12, wherein, upon selection of one of the displayed nodes, a listing of all sibling nodes of the selected displayed node and a listing of all child nodes of the selected displayed node are displayed adjacent the selected displayed node.

14. The system of claim 12, wherein, upon selection of one of the displayed nodes, a listing of at least one level of ancestor nodes of the selected displayed node, a listing of all sibling nodes of the selected displayed node, and a listing of all child nodes of the selected displayed node are displayed adjacent the selected displayed node.

15. The system of claim 12, wherein, upon selection of one of the displayed nodes, a listing of each level of ancestor nodes of the selected displayed node, a listing of all sibling nodes of the selected displayed node, and a listing of each level of descendant nodes of the selected displayed node are displayed adjacent the selected displayed node.

16. A compact interface for displaying an object hierarchy having a plurality of levels, comprising:
a first level root node of the object hierarchy;
a single second level node of the object hierarchy, wherein the second level node is a child of the first level root node; and
a single third level node of the object hierarchy, wherein the third level node is a child of the second level node;
wherein the first level root node, second level node, and third level node are displayed in a linear arrangement, wherein the first level root node and second level node are live, and wherein the third level node is live if it has any child nodes.

17. The compact interface of claim 16, wherein, upon selection of a live node, a listing of all child nodes of the selected live node is displayed adjacent the selected live node.

18. The compact interface of claim 16, wherein, upon selection of a live node, a listing of all sibling nodes of the selected live node is displayed, and a listing of all child nodes of the selected live node is displayed adjacent the listing of all sibling nodes.

19. The compact interface of claim 16, wherein, upon selection of a live node, a listing of sibling nodes of the selected live node is displayed, a listing of all child nodes of the selected live node is displayed adjacent the listing of all sibling nodes, and a listing of at least one level of ancestor nodes of the selected live node is displayed adjacent the selected live node.

20. The compact interface of claim 16, wherein, upon selection of a live node, a listing of sibling nodes of the selected live node is displayed, a listing of each level of descendant nodes of the selected live node is displayed on a first side of the listing of sibling nodes, and a listing of each level of ancestor nodes of the selected live node is displayed on a second side of the selected live node.

21. A program product stored on a recordable medium for providing a compact interface for display of an object hierarchy having a plurality of levels, which when executed comprises:
program code for displaying a first level root node of the object hierarchy;
program code for displaying a listing of all second level child nodes of the first level root node immediately adjacent the first level root node, upon selection of the first level root node; and
program code for causing the listing of all second level child nodes of the first level root node to disappear upon selection of one of the second level child nodes, and for displaying the selected second level child node immediately adjacent the first level root node.

22. The program product of claim 21, further comprising:
program code for listing all third level child nodes of the displayed second level child node immediately adjacent the displayed second child node, upon selection of the displayed second level child node; and
program code for causing the window listing all third level child nodes of the displayed second level child node to disappear, upon selection of one of the third level child nodes, and for displaying the selected third level child node immediately adjacent the displayed second child node.

23. The program product of claim 22, further comprising:
program code for selectively repeating the above-described steps for at least one subsequent level in the object hierarchy, wherein each selected node is displayed immediately adjacent a selected node from a previous level of the object hierarchy.

24. The program product of claim 23, wherein the first level root node and any selected nodes are displayed in a linear arrangement, wherein only a single node is displayed for each level of the object hierarchy.

25. The program product of claim 24, further comprising, upon selection of one of the displayed nodes:
program code for displaying a listing of all sibling nodes of the selected displayed node, and a listing of all child nodes of the selected displayed node adjacent the selected displayed node.

26. The program product of claim 24, further comprising, upon selection of one of the displayed nodes:
program code for displaying a listing of at least one level of ancestor nodes of the selected displayed node, a listing of all sibling nodes of the selected displayed node, and a listing of all child nodes of the selected displayed node.

27. The program product of claim 24, further comprising, upon selection of one of the displayed nodes:
program code for displaying a listing of each level of ancestor nodes of the selected displayed node, a listing of all sibling nodes of the selected displayed node, and a listing of each level of descendant nodes of the selected displayed node.

28. The program product of claim 21, further comprising:
program code for associating at least one of the displayed nodes with a functionality; and
program code for executing the functionality associated with the selected node, upon selection of one of the displayed nodes.
